(19) United States
(12) Patent Application Publication
(10) Pub. No.: US 2016/0357880 A1
(43) Pub. Date: Dec. 8, 2016

(54) COMPUTER-READABLE STORAGE MEDIUM, DESIGN APPARATUS, AND DESIGN METHOD

(71) Applicant: FUJITSU LIMITED, Kawasaki-shi (JP)

(72) Inventors: Kenji ISHIZUKA, Setagaya (JP); Hirooki Hayashi, Kawasaki (JP); Hidekatsu Sasaki, Kawasaki (JP); NAOYUKI NOZAKI, Kawasaki (JP)

(73) Assignee: FUJITSU LIMITED, Kawasaki-shi (JP)

(21) Appl. No.: 15/172,306

(22) Filed: Jun. 3, 2016

(30) Foreign Application Priority Data
Jun. 8, 2015 (JP) 2015-115787

(51) Int. Cl. G06F 17/50

(52) U.S. Cl. CPC G06F 17/50

(57) ABSTRACT

A computer-readable storage medium storing a design program that causes a computer to execute a process including obtaining first information and second information, the first information indicating a result of a simulation for a work including assembling or disassembling before a change of design of the object that includes a plurality of components, the second information indicating a result of the simulation for the work after the change of design, and specifying a scene, in the work, that has potential to be influenced by the change of design based on the obtained first information and the second information.

### CROSS-REFERENCE TO RELATED APPLICATION

This application is based upon and claims the benefit of priority of the prior Japanese Patent Application No. 2015-115787, filed on Jun. 8, 2015, the entire contents of which are incorporated herein by reference.

### FIELD

The embodiment discussed herein is related to a computer-readable storage medium, a design apparatus, and a design method.

### BACKGROUND

In recent years, there has been known a technique for designing a product such as an object on a simulation space using three-dimensional computer aided design (CAD). In addition, there has been known a technique for creating an animation regarding an instruction of work such as disassembling or assembling with respect to an object designed on a simulation space using a digital mock-up tool or the like.

In recent years, in a building information modeling (BIM) system for designing a building, there has been known a technique for displaying an elevator in a visually recognizable manner at the time of proposing an installation plan of the elevator (see, for example, Japanese Laid-open Patent Publication No. 2014-123233).

In recent years, in a case where it is determined that there has been a change in a component included in a three-dimensional shape model at the time of converting an image having the three-dimensional shape model viewed from a predetermined angle into a planar image, there has been known a technique for outputting a single image, which is present in a range influenced by the deformation of the component in the planar image, to a display device (see, for example, Japanese Laid-open Patent Publication No. 2007-280354).

### SUMMARY

According to an aspect of the invention, A computer-readable storage medium storing a design program that causes a computer to execute a process including obtaining first information and second information, the first information indicating a result of a simulation for a work including assembling or disassembling before a change of design of the object that includes a plurality of components, the second information indicating a result of the simulation for the work after the change of design, and specifying a scene, in the work, that has potential to be influenced by the change of design based on the obtained first information and the second information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a design method performed by an information processing apparatus;

FIG. 2 is a diagram illustrating an example of a hardware configuration of the information processing apparatus;

FIG. 3 is a block diagram illustrating an example of a functional configuration of the information processing apparatus;

FIG. 4 is a diagram illustrating an example of a component configuration of an object;

FIG. 5 is a diagram illustrating an example of product information;

FIG. 6 is a diagram illustrating an example of animation information;

FIG. 7 is a diagram illustrating an example of coincidence comparison data;

FIG. 8 is a diagram illustrating a first derivation example of the influence of a movement path;

FIG. 9 is a diagram illustrating a second derivation example of the influence of a movement path;

FIG. 10 is a diagram illustrating an example of relative distance information;

FIG. 11 is a diagram illustrating the position of components before and after the change of design and an example in which a component is grasped by a human body model;

FIG. 12 is a diagram illustrating an example of joint load information;

FIG. 13 is a diagram illustrating an example of the influence on an assembling order due to the change of a connection relationship between components;

FIG. 14 is a diagram illustrating an example of relationship information;

FIG. 15 is a diagram illustrating an example of the change of an animation;

FIG. 16 is a diagram illustrating an example of the influence of visibility;

FIG. 17 is a diagram illustrating an example of proportion information;

FIGS. 18A to 18C are diagrams illustrating an example of a screen;

FIG. 19 is a flow chart illustrating an example of a processing procedure performed by the information processing apparatus;

FIG. 20 is a flow chart illustrating details of a division process (step S1902) illustrated in FIG. 19;

FIG. 21 is a flow chart (Part 1) illustrating details of a determination process (step S1907) illustrated in FIG. 19;

FIG. 22 is a flow chart (Part 2) illustrating details of the determination process (step S1907) illustrated in FIG. 19;

FIG. 23 is a flow chart (Part 3) illustrating details of the determination process (step S1907) illustrated in FIG. 19;

FIG. 24 is a flow chart (Part 4) illustrating details of the determination process (step S1907) illustrated in FIG. 19; and

FIG. 25 is a flow chart (Part 5) illustrating details of the determination process (step S1907) illustrated in FIG. 19.

### DESCRIPTION OF EMBODIMENT

However, an operator visually confirms influence in each scene included in an animation regarding an instruction of work with respect to an object including components due to the change of design of a component or the like, and thus the presence or absence of influence may not be determined depending on the level of working skill of an operator.

In one aspect, an object of an embodiment is to provide a design program, an information processing apparatus, and a design method which are capable of facilitating the recognition of influence on a scene due to the change of design of a component.

Hereinafter, a design program, an information processing apparatus, and a design method according to an aspect of an embodiment will be described in detail.

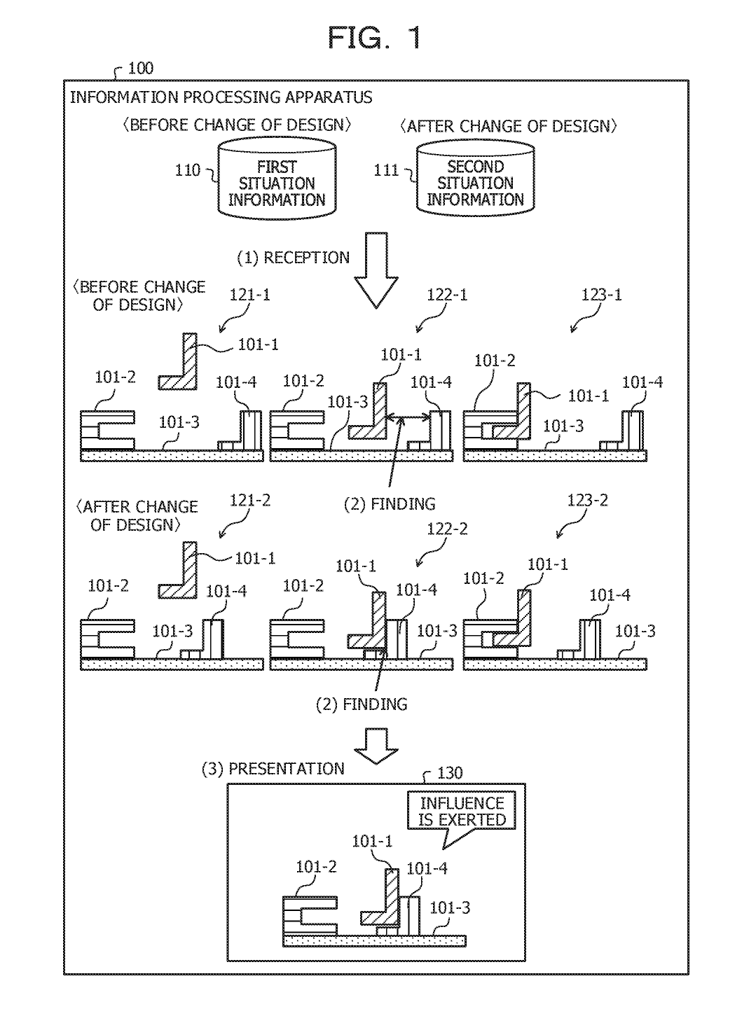

FIG. 1 is a diagram illustrating an example of a design method performed by an information processing apparatus. An information processing apparatus 100 is a computer that supports the design of an animation regarding work with respect to an object designed in a simulation space.

Here, the simulation space refers to a virtual three-dimensional space which is simulated on a computer. Specifically, for example, the simulation space is a space which is virtually set within the information processing apparatus 100 by CAD for designing a three-dimensional assembly. For example, a three-dimensional orthogonal coordinate system having an X-axis, a Y-axis, and a Z-axis is defined for the simulation space. The object is a product, an assembling part, a trial product of a product or an assembling part, a model of a building, or the like. The object is also called a product for convenience of understanding. The product is a digital device such as a camera and a personal computer (PC), a vehicle, or the like, and is not particularly limited.

The animation refers to an aggregation of a plurality of scenes. The scene refers to a series of situations extracted during a time between when one component starts to move and when the component stops. The scene is shown by situation information. In addition, examples of the work with respect to an object include assembling work, disassembling work, and the like. For this reason, the animation indicates an assembling order, a disassembling order, and the like.

In related art, influence on an animation regarding work with respect to an object including components due to the change of design of a component or the like is visually confirmed. However, since there is a problem of complexity due to a large number of determination items for the confirmation, confirmation results of the influence may vary depending on the level of working skill of an operator such as a designer, and the operator may not determine the presence of absence of influence.

In addition, for example, a tool for creating an animation includes a tool for checking interference between a certain component and another component, but a function of checking interference is a portion of influences on a movement path of a movement component. The portion of influence refers to a case where the component after the change blocks the movement path of the movement component, and the like. For example, in the interference checking, it is not possible to determine a case where the changed component does not block the movement path of the movement component but is located at a position where the changed component is not likely to attach the movement component during the attachment of the movement component.

Consequently, in the present embodiment, the information processing apparatus 100 finds influence on work with respect to an object including a component after the change of design, due to the change of the component. In order to find influence on work, the information processing apparatus 100 finds four influences of influence on a movement path of a component, influence on a human body during the grasping of an assembly including the component after the change, influence on visibility, and influence on a work procedure due to the change of a connection relationship between components.

Thereby, it is possible to facilitate the specification of influence on a scene due to the change of design of a component. Therefore, a designer can facilitate specification of a location where design regarding work indicated by an animation after the change is changed and to facilitate the design of an animation.

Here, the simulation space refers to a virtual three-dimensional space which is simulated on a computer. Specifically, for example, the simulation space refers to a space which is virtually set within the information processing apparatus 100 by CAD for designing a three-dimensional assembly. For example, a three-dimensional orthogonal coordinate system including an X-axis, a Y-axis, and a Z-axis is defined for the simulation space. The object is a product, an assembling part, a trial product of a product or an assembling part, a model of a building, or the like. The product is a digital device such as a camera and a PC, a vehicle, or the like, and is not particularly limited.

The animation refers to an aggregation of a plurality of scenes. The scene refers to a series of situations extracted during a time between when one component starts to move and when the component stops. The scene is shown by situation information. The situation information is also referred to as scene information. The scene information includes information regarding a field of view of a scene and contents related to an ID and movement of a movement component which is moving. It is possible to determine a point of view based on the information regarding a field of view.

As illustrated in (1) of FIG. 1, in a case where the information processing apparatus 100 changes a first component among a plurality of components included in an object to be designed, the information processing apparatus receives inputs of first situation information 110 and second situation information 111. In FIG. 1, the plurality of components is, for example, components 101-1 to 101-4. In FIG. 1, the first component is, for example, the component 101-4. The first situation information 110 is information used for an instruction of work with respect to an object and indicating a series of situations related to an object including the first component before the change in a simulation space. The second situation information 111 is information used for an instruction of work with respect to an object and indicating a series of situations related to an object including the first component after the change in a simulation space. The series of situations is scenes included in an animation as described above. The situation information is also referred to as scene information.

In the example of FIG. 1, a scene to be processed includes three situations. In the scene to be processed, the component 101-1 moves and is finally attached to the component 101-2.

The information processing apparatus 100 finds influence on work with respect to an object including a first component after the change of design, due to the change of the first component, based on the received first situation information 110 and second situation information 111. Specifically, the information processing apparatus 100 finds influence on work by comparing, for example, a series of situations indicated by the first situation information 110 with a series of situations indicated by the second situation information 111. For example, the information processing apparatus 100 can find influence on work by finding at least one of influence on a movement component, influence on a human body grasping a component, influence on the procedure of work, and influence on the visibility of a component.

Here, a description will be given using an example of influence on a movement component. The information processing apparatus 100 finds influence on a movement path of at least one component of a first component and a second component other than the first component among a plurality of components, due to the first component after the change when the at least one component moves. In FIG. 1, the second component is, for example, the component 101-1.

More specifically, the information processing apparatus 100 finds influence on a movement path, based on a distance between the first component and the second component before the change in a series of situations and a distance between the first component and the second component after the change in a series of situations based on second object information.

In the example of (2) of FIG. 1, the information processing apparatus 100 finds a distance between the component 101-1 and the component 101-4 in each of a series of situations each before and after the change of design. Situations indicated by the first situation information 110 are situations 121-1, 122-1, and 123-1. Situations indicated by the second situation information 111 are situations 121-2, 122-2, and 123-2. In (2) of FIG. 1, for example, a distance in the situation 122-1 and a distance in the situation 122-2 are the shortest distances each before and after the change of design.

The information processing apparatus 100 may determine that influence is exerted on a movement component in a case where there is a difference between the shortest distances obtained before and after the change of design by comparison therebetween. In addition, when a difference between the shortest distances obtained before and after the change of design is equal to or greater than a threshold value, the information processing apparatus 100 may determine that influence is exerted on the movement component. As illustrated in (2) of FIG. 1, a distance between the component 101-1 and the component 101-4 after the change of design becomes smaller than a distance therebetween before the change of design, and thus the component 101-1 is not likely to be assembled to the component 101-2.

For this reason, as illustrated in (3) of FIG. 1, the information processing apparatus 100 presents information indicating that influence is exerted on a location determined to be influenced. Specifically, in the example of (3) of FIG. 1, the information processing apparatus 100 displays information indicating that influence is exerted on a movement component, on a screen 130 that displays a scene to be processed during the reproduction of an animation.

Thereby, it is possible to facilitate the specification of influence on a scene due to the change of design of a component. Therefore, a designer can facilitate the specification of a location where design related to work indicated by an animation after the change is changed, and can facilitate the design of an animation.

Example of Hardware Configuration of Information Processing Apparatus 100

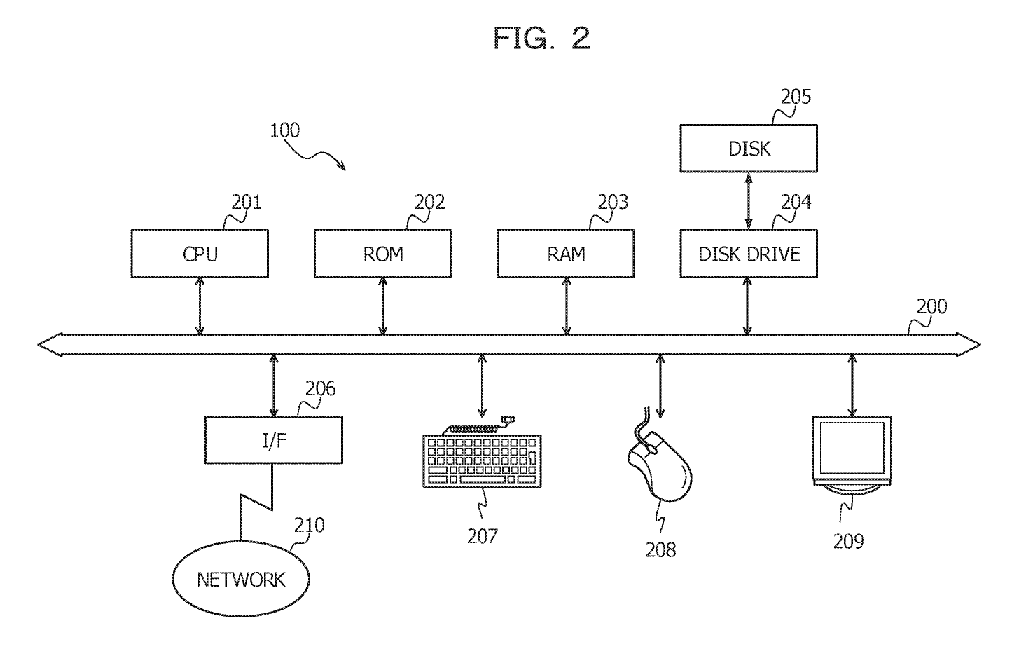

FIG. 2 is a diagram illustrating an example of a hardware configuration of an information processing apparatus. The information processing apparatus 100 includes a central processing unit (CPU) 201, a read only memory (ROM) 202, a random access memory (RAM) 203, a disk drive 204, and a disk 205. The information processing apparatus 100 includes an interface (I/F) 206, a keyboard 207, a mouse 208, and a display 209. In addition, the CPU 201, the ROM 202, the RAM 203, the disk drive 204, the I/F 206, the keyboard 207, the mouse 208, and the display 209 are connected to each other through a bus 200.

Here, the CPU 201 controls the overall information processing apparatus 100. The ROM 202 stores a program such as a boot program. The RAM 203 is used as a work area of the CPU 201. The disk drive 204 reads and writes data from and in the disk 205 under the control of the CPU 201. The disk 205 stores data which is written under the control of the disk drive 204. Examples of the disk 205 include a magnetic disk, an optical disk, and the like.

The I/F 206 is connected to a network 210 such as a local area network (LAN), a wide area network (WAN), or the Internet through a communication line, and is connected to other devices through the network 210. The I/F 206 takes charge of an internal interface together with the network 210, and controls the input and output of data from an external device. For example, a modem, a LAN adapter, or the like can be adopted as the I/F 206.

The keyboard 207 and the mouse 208 are interfaces that input various pieces of data by a user's operation. The display 209 is an interface that outputs data in response to an instruction of the CPU 201.

Although not shown in the drawing, the information processing apparatus 100 may be provided with an input device that fetches an image or a movie from a camera or an input device that fetches a sound from a microphone. Although not shown in the drawing, the information processing apparatus 100 may be provided with an output device such as a printer.

In the present embodiment, a personal computer is taken as an example of a hardware configuration of the information processing apparatus 100. However, the embodiment is not limited thereto, and a server or the like may be taken as an example. In a case where the information processing apparatus 100 is a server, the information processing apparatus 100, a user's operable device, the display 209, and the like may be connected to each other through the network 210.

Example of Functional Configuration of Information Processing Apparatus 100

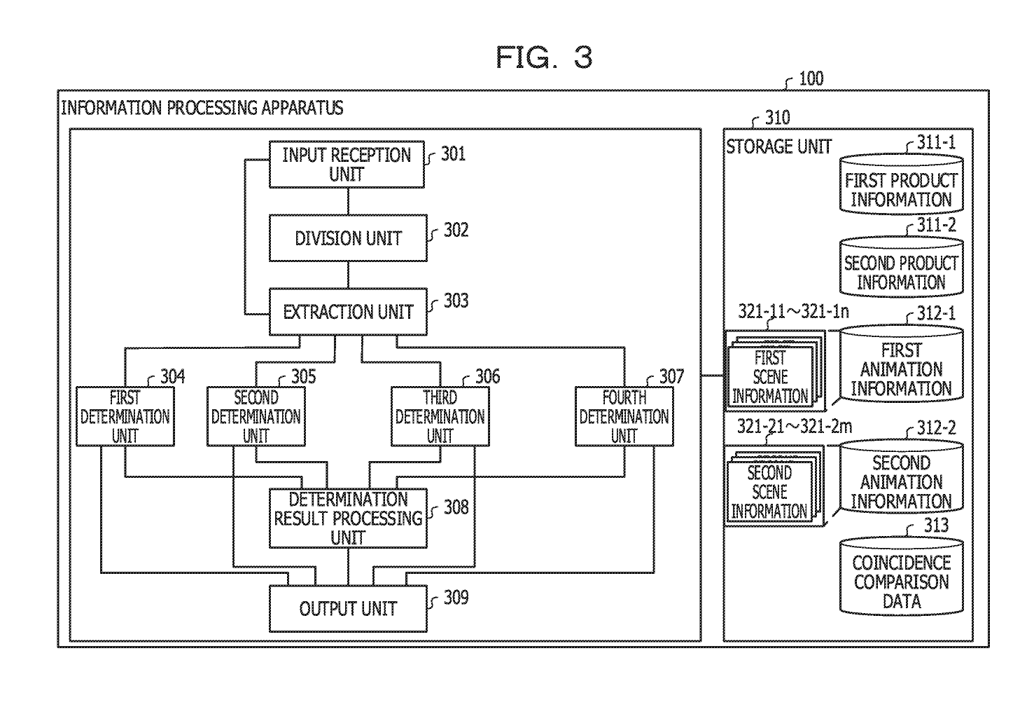

FIG. 3 is a block diagram illustrating an example of a functional configuration of an information processing apparatus. The information processing apparatus 100 includes an input reception unit 301, a division unit 302, an extraction unit 303, a first determination unit 304, a second determination unit 305, a third determination unit 306, a fourth determination unit 307, a determination result processing unit 308, an output unit 309, and a storage unit 310. Processing of a control unit from the input reception unit 301 to the output unit 309 is coded into a program stored in the storage unit 310 such as the ROM 202, the RAM 203, or the disk 205 which can be accessed by, for example, the CPU 201 illustrated in FIG. 2. The CPU 201 reads out the program from the storage unit 310 and executes the processing coded into the program. Thereby, the processing of the control unit is realized. In addition, processing results of the control unit are stored in, for example, the storage unit 310.

First, the input reception unit 301 receives input of first product information 311-1 and first animation information 312-1 regarding before the change of design, second product information 311-2 and second animation information 312-2 after the change of design, and coincidence comparison data 313. The inputs to the input reception unit 301 may be performed by an application such as 3D CAD, or may be performed by a user's operation with respect to an input device such as the keyboard 207 or the mouse 208. The input reception unit 301 stores the received first product information 311-1 and first animation information 312-1, second product information 311-2 and second animation information 312-2, and coincidence comparison data 313 in the storage unit 310.

The first animation information 312-1 indicates an animation regarding an instruction of work with respect to an object before the change of design. Examples of the work include assembling, disassembling, and the like. The first animation information 312-1 includes pieces of first scene information 321-11 to 321-1n. For example, n is an integer of 1 or greater. The pieces of first scene information 321-11 to 321-1n include, for example, point-of-view information indicating a point of view.

The second animation information 312-2 indicates an animation regarding an instruction of work with respect to an object after the change of design. The second animation information is pieces of second scene information 321-21 to 321-2m. For example, m is an integer of 1 or greater. The pieces of second scene information 321-21 to 321-2m include, for example, point-of-view information indicating a point of view.

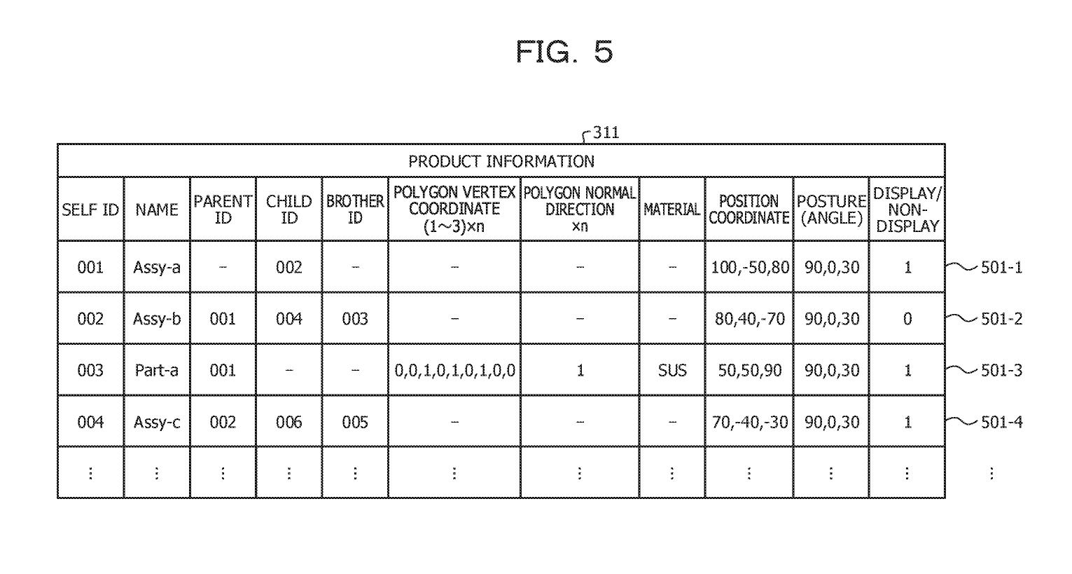

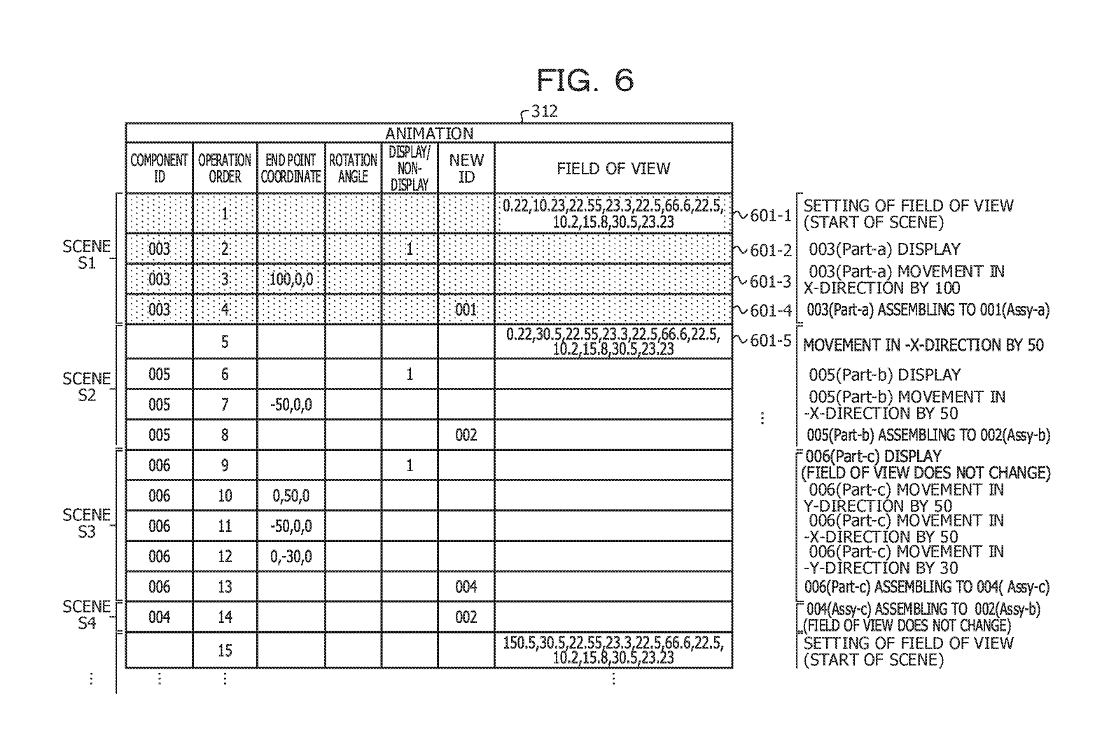

Here, the movement of a component, a designer's procedure, and the like in the animation indicated by the second animation information 312-2 are the same as those in the animation indicated by the first animation information 312-1. A detailed example of animation information 312 is illustrated in FIG. 6. The first product information 311-1 is object information indicating a component and the position of the component with respect to each of a plurality of components included in an object before the change of design. The second product information 311-2 is object information indicating a component and the position of the component with respect to each of a plurality of components included in an object after the change of design. A detailed example of product information 311 is illustrated in FIG. 5.

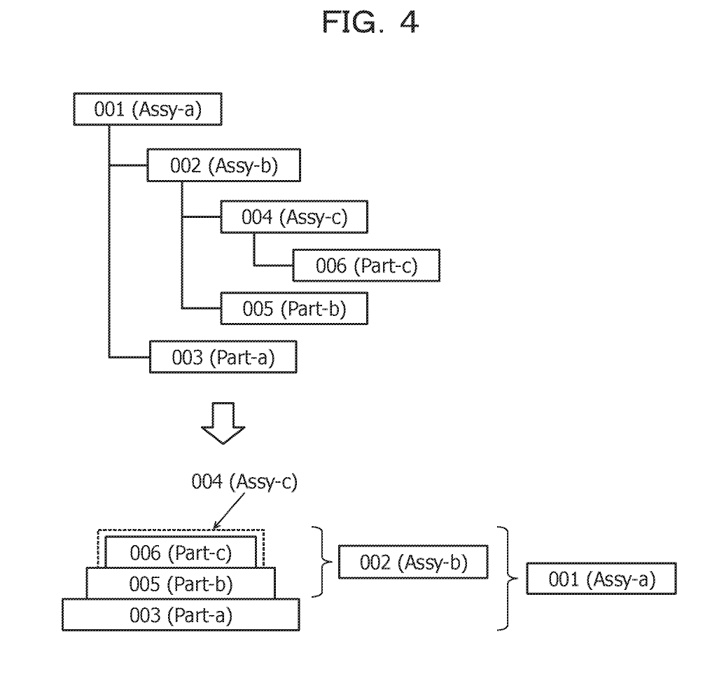

FIG. 4 is a diagram illustrating an example of a component configuration of an object. Here, a component configuration of an object indicated by the product information 311 will be described before detailed descriptions of the product information 311, the animation information 312, and the coincidence comparison data 313 are given. Component IDs such as “001” to “005” illustrated in FIG. 4 are pieces of identification information capable of uniquely specifying a component. Part, Assy, and the like are names of components. Here, for convenience of understanding, a component including Assy in its name is an assembling part, and a component including Part in its name is a single component.

A final assembling part of an object is a component Assy-a having a component ID of “001”. The component Assy-a includes a component Assy-b having a component ID of “002” and a component Part-a having a component ID of “003”. Child components of the component Assy-a are the component Assy-b and the component Part-a. In other words, a parent component of the component Assy-b and the component Part-a is the component Assy-a. A brother component of the component Assy-b is the component Part-a.

The component Assy-b includes a component Assy-c having a component ID of “004” and a component Part-b having a component ID of “005”. Child components of the component Assy-b are the component Assy-c and the component Part-b. In other words, a parent component of the component Assy-c and the component Part-b is the component Assy-b. A brother component of the component Assy-c is the component Part-b.

The component Assy-c includes a component Part-c having a component ID of “006”. A child component of the component Assy-c is the component Part-c. A parent component of the component Part-c is the component Assy-c.

FIG. 5 is a diagram illustrating an example of product information. The product information 311 is a set of pieces of component information indicating components included in an object to be designed. The product information 311 includes fields such as a component ID, a name, a parent ID, a child ID, a brother ID, a polygon vertex coordinate, a polygon normal direction, a material, a position coordinate, a posture, and display/non-display. Information is set in the fields, and thus pieces of component information (501-1 to 501-4 and the like) are stored. The product information 311 is stored in the storage unit 310.

Identification information capable of uniquely specifying a component is set in the field of a component ID. A name of a component is set in the field of a name.

In a case of being a component included in a component to become an assembly, a component ID of the component to become the assembly is set in the field of a parent ID. In a case of being a component to become an assembly, a component ID of any of components included in the component to become the assembly is set in the field of a child ID. In a case of being a component included in a component to become an assembly, a component ID of a component included in components to become the assembly other than the component is set in the field of a brother ID.

A vertex coordinate value of a polygon included in a component is set in the field of a polygon vertex coordinate. A normal direction of a polygon included in the surface of a component is set in the field of a polygon normal direction.

Information indicating a material of a component is set in the field of a material. For example, a material of the component Part-a is stainless steel (SUS). For example, “-” is set in a case where a material is not particularly designated. A coordinate value in which the origin of a component is disposed is set in the field of a position coordinate. Since, for example, a three-dimensional orthogonal coordinate system having an X-axis, a Y-axis, and a Z-axis is defined in a simulation space, one coordinate value is shown by an X value, a Y value, and a Z value.

A direction of a component disposed with respect to coordinate axes is set in the field of a posture. Taking the component Assy-a as an example, a component is disposed in a direction at 90 degrees in the X-axis direction, 0 degrees in the Y-axis direction, and 30 degrees in the Z-axis direction. The display or non-display of a component is set in the field of a display/non-display. Although not shown in the drawing, the color of a component, and the like may be set as component information 501.

FIG. 6 is a diagram illustrating an example of animation information. The animation information 312 is information indicating an animation which is used for an instruction of work such as assembling or disassembling on, for example, a digital mock-up tool. The animation information 312 is set of a plurality of pieces of scene information 321.

The animation information 312 includes fields such as a component ID, an operation order, an end point coordinate, a rotation angle, display/non-display, a new ID, and a field of view. Information is set in the fields, and thus records (601-1 and the like) are stored. The animation information 312 is stored in the storage unit 310. A record group having the same consecutive component IDs is one piece of scene information 321.

Records 601 are arranged based on an operation order in an animation, and records 601 having the same consecutive component IDs are one piece of scene information 321. A record 601 having no same consecutive component IDs is included in the subsequent scene information 321.

Identification information capable of uniquely specifying a component is set in the field of a component ID. An order of consecutive operations of an animation is set in the field of an operation order. The amount of movement of a component indicated by a component ID in each axis direction is set in the field of an end point coordinate. Taking a record 601-3 as an example, a component Part-a having a component ID of “003” moves by 100 in the X-axis direction. A rotation angle in a case where a component indicated by a component ID rotates is set in the field in the rotation angle. Whether to perform a display is set in the field of the display/non-display.

A component ID after the operation of a component indicated by a component ID is set in the field of the new ID. Taking a record 601-3 and a record 601-4 as examples, a component Part-a having a component ID of “003” moves by 100 in the X-axis direction and is then assembled to a component Assy-a having a component ID of “001”.

A field of view for displaying a component indicated by a component ID on a simulation space at the time of the start of a scene is set in the field of the field of view. A point of view can be determined by the field of view. In addition, the degree of visibility to be described later may be obtained by a field of view to be set.

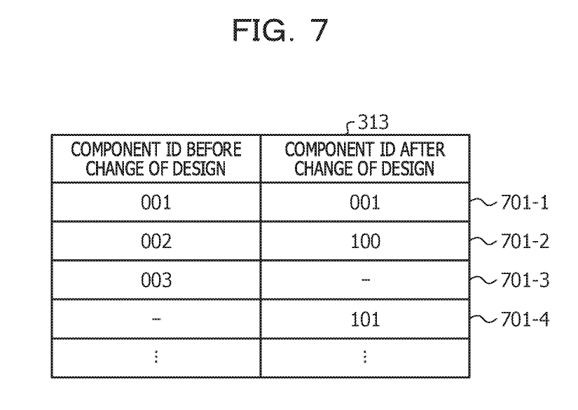

FIG. 7 is a diagram illustrating an example of coincidence comparison data. The coincidence comparison data 313 is a combination of component IDs before and after the change in a case where a component ID capable of identifying a component before and after the change of design is changed. The coincidence comparison data 313 includes fields of, for example, a component ID before the change of design and a component ID after the change of design. Information is set in the fields, and thus records (701-1 to 701-4 and the like) are stored.

A component ID before the change of design is set in the field of the component ID before the change of design. A component ID after the change of design is set in the field of the component ID after the change of design.

For example, a component Assy-b having a component ID of “002” is changed to a component having a component ID of “100”. Since a component ID corresponding to a component ID of “003” is not present, a component Part-a having a component ID of “003” disappears after the change of design. Since a component ID before the change of design corresponding to a component ID after the change of design of “101” is not present, a component having a component ID of “101” is a component which is added after the change of design.

Next, the division unit 302 generates scene information 321 indicating each of a plurality of scenes obtained by dividing an animation indicated by animation information 312. As described above, the scene information 321 is a group of some records 601 included in the animation information 312. In the example of FIG. 3, the information processing apparatus 100 includes the division unit 302, and the division unit 302 generates scene information 321 by dividing an animation into a plurality of scenes. However, the embodiment is not limited thereto, and the input reception unit 301 may receive an input of the scene information 321 obtained by the division. The input reception unit 301 also receives an input of a component ID indicating a target component to be subjected to the determination of influence at the time of receiving an input of the scene information 321. When the input reception unit 301 receives the scene information 321, the input reception unit also receives an input of component information 501 indicating a component included in a scene indicated by the scene information 321, instead of receiving product information 311.

Specifically, the division unit 302 determines a component of interest in an animation before the change of design which is indicated by, for example, first animation information 312-1. The component of interest is a component that starts to move, for example, when a position where a component first starts to move from the head of an animation before the change of design is set as a scene start position. In a case where a plurality of components starting to move is present, the division unit 302 may sequentially select components of interest as component-of-interest candidates. The division unit 302 divides the components of interest into scenes to thereby generate scene information 321. For example, the division unit 302 extracts component information 501 of a component which is present in a scene from first product information 311-1, with respect to each of the scenes obtained by the division.

For example, the division unit 302 determines a component of interest in an animation indicated by second animation information 312-2. The component of interest is a component that starts to move, for example, when a position where a component first starts to move from the head of an animation after the change of design is set as a scene start position. In a case where a plurality of components starting to move is present, the division unit 302 may sequentially select components of interest as component-of-interest candidates. The division unit 302 divides the components of interest into scenes to thereby generate scene information 321. For example, the division unit 302 extracts component information 501 of a component which is present in a scene from second product information 311-2, with respect to each of the scenes obtained by the division. The division unit 302 determines a combination of scenes that are coincident with each other before and after the change of design, using coincidence comparison data 313 and start positions of the scenes.

For example, the extraction unit 303 may sequentially perform processing on a combination of scenes corresponding as targets to be processed, on the scenes obtained by the division performed by the division unit 302. A combination of scenes to be processed is simply referred to as a scene to be processed. In addition, a scene after the change of design among scenes to be processed is also referred to as a scene to be processed after the change of design, and a scene before the change of design among scenes to be processed is also referred to as a scene to be processed before the change of design.

The extraction unit 303 extracts a component included in a scene to be processed each before and after the change of design, based on scene information 321 regarding the scene to be processed. The extraction unit 303 extracts component information 501 of a component of interest during scene division from scene information 321 indicating a scene to be processed and component information 501 extracted with respect to a component which is present in the scene to be processed, each before and after the change of design. The extraction unit 303 extracts component information 501 of a component to be subjected to the change of design, based on a scene to be processed after the change of design, component information 501 of a component which is present in the scene to be processed, and coincidence comparison data 313.

Next, the first determination unit 304 to the fourth determination unit 307 find influence on work with respect to an object including the first component after the change, due to the change of the first component, based on first scene information 321-1x and second scene information 321-2y. Here, x is any of 1 to n, and y is any of 1 to m. In addition, x and y are determined by a combination of correlations. The first determination unit 304 finds influence on a movement path of a movement component in a scene to be processed, due to the change of design of the component, to thereby find influence on work. The second determination unit 305 finds influence on a human body model in a case where the human body model grasps a component in a scene to be processed to thereby find influence on work. The third determination unit 306 finds influence on the procedure of work due to the change of a connection relationship between components to thereby find influence on work. The fourth determination unit 307 finds influence on the visibility of other components due to the change of design of a component to thereby find influence on work.

Here, although not shown in the drawing, the information processing apparatus 100 may be configured such that at least one of four determinations performed by the first determination unit 304 to the fourth determination unit 307 is performed. In addition, although not shown in the drawing, the information processing apparatus 100 may be configured such that an operator such as a designer performs determination selected from the four determinations. The information processing apparatus 100 may be configured such that, for example, a selection screen capable of selecting the four determinations is displayed on the display 209. The information processing apparatus 100 receives an input of selection by the operation of the keyboard 207, the mouse 208, or the like. The information processing apparatus 100 may determine influence according to the received selection result.

In addition, in the present embodiment, a description is given of an example in which the first determination unit 304 to the fourth determination unit 307 determine the presence or absence of influence on work, but the determinations performed by the first determination unit 304 to the fourth determination unit 307 are determinations on whether or not there is the possibility of influence on work. For this reason, an operator such as a designer may determine the presence or absence of final influence, based on results of the determinations performed by the first determination unit 304 to the fourth determination unit 307.

Next, the first determination unit 304 finds influence on a movement path of at least one component of a first component and a second component other than the first component among a plurality of components included in an object, due to the first component after the change when the at least one component moves. The first component is a component to be subjected to the change of design, and the second component is the above-mentioned component of interest. The first determination unit 304 finds influence on a movement path, based on a distance between the first component and the second component before the change in a series of situations based on first product information 311-1 and a distance between the first component and the second component after the change in a series of situations based on second product information 311-2.

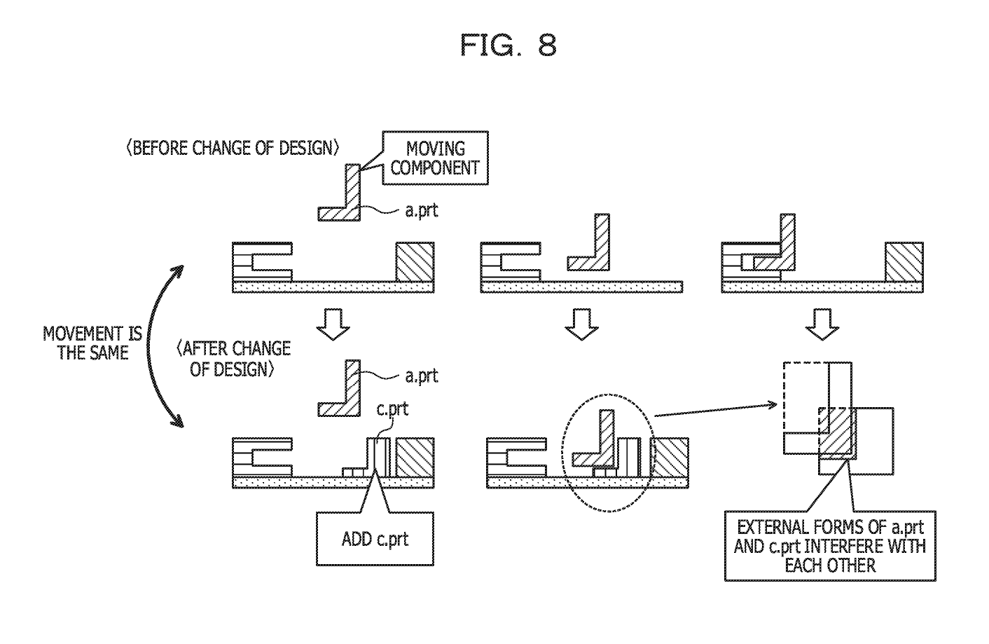

FIG. 8 is a diagram illustrating a first derivation example of the influence of a movement path. In FIG. 8, a second component which is a component of interest is, for example, a movement component a.prt. In addition, in FIG. 8, a component c.prt is added by the change of design, and thus a first component is, for example, the component c.prt.

The first determination unit 304 determines whether an inclusive external form of a component of interest a.prt included in a scene to be processed and an inclusive external form of a component other than the component of interest a.prt which is included in the scene to be processed interfere with each other before the change of design. The first determination unit 304 determines whether the inclusive external forms interfere with each other, based on first scene information 321-1x regarding the scene to be processed and component information 501 regarding the component included in the scene to be processed. The first determination unit 304 determines whether an inclusive external form of a component of interest a.prt included in a scene to be processed and an inclusive external form of a component other than the component of interest a.prt which is included in the scene to be processed interfere with each other after the change of design. The first determination unit 304 determines whether the inclusive external forms interfere with each other, based on second scene information 321-2y and component information 501 regarding the component included in the scene to be processed. Here, in FIG. 8, a determination is made on whether an inclusive external form of a component other than the component c.prt which is the first component and an inclusive external form of the movement component a.prt which is the second component interfere with each other.

The first determination unit 304 determines a combination to be subjected to comparison before and after the change of design, based on coincidence comparison data 313. The first determination unit 304 determines whether determination results are coincident with each other with respect to the determined combination. In the example of FIG. 8, a component before the change of design corresponding to the component c.prt after the change of design is not present. In a case where a component is not present, it is assumed here that interference is determined not to be made. On the other hand, an inclusive external form of the component c.prt after the change of design and the inclusive external form of the component of interest a.prt interfere with each other. For this reason, the first determination unit 304 determines that determination results are not coincident with each other with respect to a combination of a case of no component before the change of design and the component c.prt after the change of design. The first determination unit 304 stores, in the storage unit 310, a combination in which it is determined that results of determination on the presence or absence of influence are not coincident with each other and results of determination on the presence or absence of influence with respect to the combination, in association with each other.

In addition, the first determination unit 304 calculates a distance between a component of interest and a component other than the component of interest which is included in a scene to be processed, based on component information 501 regarding the component of interest and component information 501 regarding the component other than the component of interest, each before and after the design of the scene to be processed.

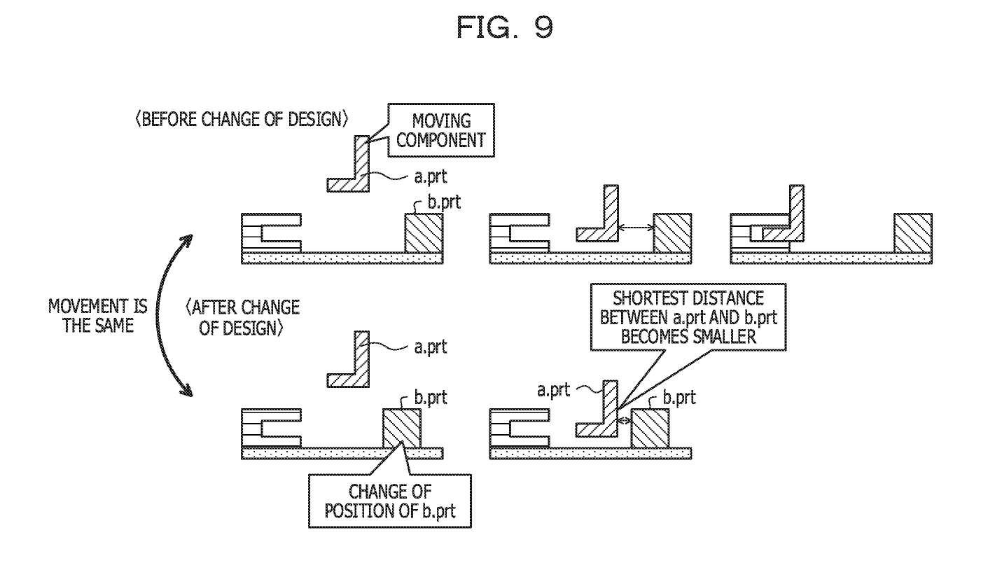

FIG. 9 is a diagram illustrating a second derivation example of the influence of a movement path. For example, a movement component a.prt is a component of interest. In the example of FIG. 9, a component b.prt is a component to be changed, and the position thereof is changed. Movement paths of the movement component a.prt are the same as each other before the change of design and after the change of design, but the shortest distance between the movement component a.prt and the component b.prt becomes smaller than that before the change of design, due to the change of the position of the component b.prt. In this manner, in a case where the shortest distance becomes smaller, there is a high possibility of influence being exerted on the movement path of the movement component.

The first determination unit 304 calculates a distance between a component of interest and a component other than the component of interest which is included in a scene to be processed, based on first scene information 321-1x regarding the scene to be processed before the change of design and component information 501 regarding the component included in the scene to be processed. The first determination unit 304 calculates a distance between a component of interest and a component other than the component of interest which is included in a scene to be processed, based on second scene information 321-2y regarding the scene to be processed after the change of design and component information 501 regarding the component included in the scene to be processed.

For example, the first determination unit 304 stores, as relative distance information, the shortest distance among distances calculated before the change of design and the shortest distance among distances calculated after the change of design, with respect to each of components other than a component of interest which are included in a scene to be processed.

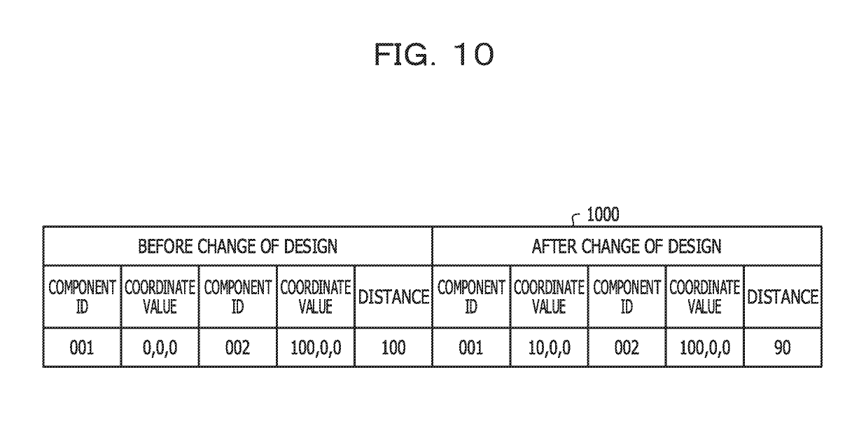

FIG. 10 is a diagram illustrating an example of relative distance information. For example, relative distance information 1000 includes fields of a component ID and a coordinate value of a component of interest, a component ID and a coordinate value of a component other than the component of interest, and a distance between the component of interest and the component other than the component of interest, before the change of design. In addition, for example, the relative distance information 1000 includes fields of a component ID and a coordinate value of a component of interest, a component ID and a coordinate value of a component other than the component of interest, and a distance between the component of interest and the component other than the component of interest, after the change of design. The relative distance information 1000 is stored in the storage unit 310.

According to the relative distance information 1000, for example, when a component having a component ID of “001” has a coordinate value of (0, 0, 0) before the change of design, a distance between the component having the component ID of “001” and a component having a component ID of “002” and a coordinate value of (100, 0, 0) is the smallest which is 100.

In addition, according to the relative distance information 1000, for example, when a component having a component ID of “001” has a coordinate value of (10, 0, 0) after the change of design, a distance between the component having the component ID of “001” and a component having a component ID of “002” disposed at a position of a coordinate value of (100, 0, 0) is the smallest which is 90.

A designer may determine the presence or absence of influence on a movement path of a movement component, based on relative distance information 1000 generated by the first determination unit 304. In addition, the first determination unit 304 may compare distances before and after the change of design, for example, in the relative distance information 1000. Specifically, the first determination unit 304 may determine whether a value obtained by subtracting the distance after the change of design from the distance before the change of design is equal to or greater than a threshold value, to thereby determine the presence or absence of influence on a movement path. The threshold value may be set based on an experience value of the designer or the like. For example, in a case where the first determination unit 304 determines that the value is equal to or greater than the threshold value, it is determined that there is a high possibility of influence being exerted on the movement path.

On the other hand, in a case where the first determination unit 304 determines that the value is not equal to or greater than the threshold value, it is determined that there is a low possibility of influence being exerted on the movement path. According to the relative distance information 1000 illustrated in FIG. 10, a value obtained by subtracting the distance after the change of design from the distance before the change of design is 10. In a case where the threshold value is 5, the first determination unit 304 determines that the value is equal to or greater than the threshold value.

Next, referring back to a description of FIG. 3, the second determination unit 305 finds influence on a human body due to a first component after the change in a case where the human body holds a third component including the first component after the change in a simulation space. The second determination unit 305 finds influence on the human body, based on first scene information 321-1x and second scene information 321-2y. Examples of the influence on the human body include an increase in a load on a joint of the human body, and the like. The holding of the component by the human body in the simulation space refers to the holding of the component by a human body model simulating the human body in the simulation space. When a load on a joint of the human body model increases, the human body model is not likely to hold the third component. Consequently, the second determination unit 305 calculates a load on the joint of the human body model before the change of design and a load on the joint of the human body model after the change of design.

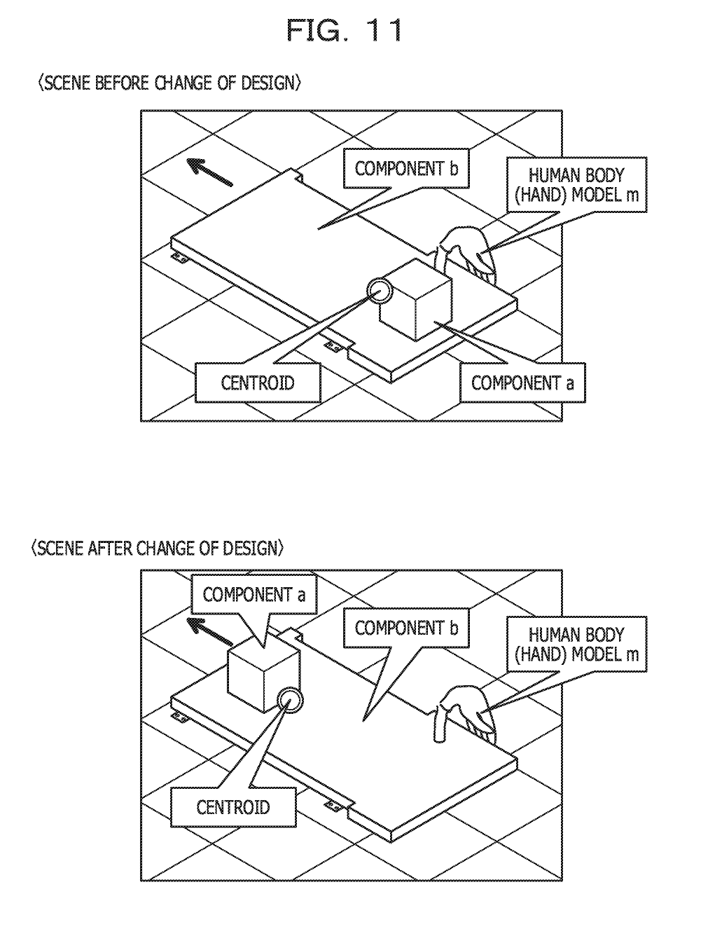

The second determination unit 305 finds influence on a human body, based on the amount of load of each joint of the human body in a case where a human body model holds a third component including the first component before the change, and the amount of load on each joint of the human body in a case where the human body model holds the third component including the first component after the change. A detailed example will be described with reference to FIG. 11.

FIG. 11 is a diagram illustrating the position of components before and after the change of design and an example in which a component is grasped by a human body model. In FIG. 11, a first component is, for example, a component a. In addition, in FIG. 11, a third component is, for example, a component b. A human body model m holds the component b including the component a and moves the component b in a direction of an arrow in a simulation space.

Since the position of the component a in the component b is changed before and after the change of design, the position of the centroid of the component a deviates. For this reason, a load on each joint of the human body model m changes in a case where the human body model m grasps the component b by one hand. For example, when a load increases, the human body model m is not likely to grasp the third component as described above. For this reason, here, for example, the second determination unit 305 specifies a change in the amount of load on each joint before and after the change of design to thereby determine influence on the human body model m.

The second determination unit 305 derives the amount of load on a joint of the human body model m in a case where the human body model m grasps the component b, based on first scene information 321-1x regarding a scene to be processed and component information 501 regarding a component included in the scene to be processed. Here, the amount of load may be acquired from a computer that executes an application capable of deriving the amount of load, and the information processing apparatus 100 may execute the application, and thus a method of deriving the amount of load is not particularly limited.

The second determination unit 305 derives the amount of load on a joint of the human body model m in a case where the human body model m grasps the component b, based on first scene information 321-1x indicating a scene to be processed after the change of design and component information 501 regarding a component included in the scene to be processed. The second determination unit 305 stores the derived amounts of load in joint load information.

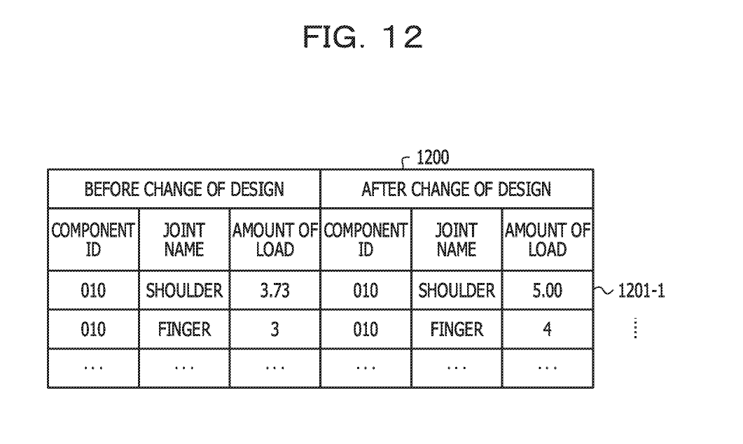

FIG. 12 is a diagram illustrating an example of joint load information. The joint load information 1200 includes, for example, fields of a component ID, a joint name, and the amount of load before the change of design, and fields of a component ID, a joint name, and the amount of load after the change of design. Information in the fields is set, and thus records (1201-1 and the like) are stored. The joint load information 1200 is stored in the storage unit 310.

Identification information indicating a component including a component to be changed is set in the field of the component ID. Identification information indicating a joint included in a human body model m is set in the field of the joint name. A derived amount of load is set in the field of the amount of load.

According to the record 1201-1, in a case where a component ID is 010, a joint name is a shoulder, the amount of load before the change of design is “3.73”, and the amount of load after the change of design is “5.00”.

For example, in a case where the amounts of load are different from each other before and after the change of design, the second determination unit 305 may determine that influence is exerted on the human body model m. In a case where the amounts of load are not different from each other, the second determination unit may determine that influence is not exerted on the human body model m. Alternatively, for example, in a case where a difference between the amounts of load before and after the change of design is greater than a threshold value, the second determination unit 305 determines that there is a change in component having a great change in the amount of load and that influence is exerted on the human body model m.

For example, in a case where the difference is equal to or less than the threshold value, the second determination unit 305 may determine that there is a change in component having a small change in the amount of load and that influence is not exerted on the human body model m. For example, the threshold value may be set by an operator based on an experience value. Alternatively, in a case where a value obtained by subtracting the amount of load after the change of design from the amount of load before the change of design is equal to or less than the threshold value, the second determination unit 305 may determine that there is a change in component having a great change in the amount of load and that influence is exerted on the human body model m. In a case where the value obtained by subtracting the amount of load after the change of design from the amount of load before the change of design is not equal to or less than the threshold value, the second determination unit 305 may determine that there is a change in component having a small change in the amount of load and that influence is not exerted on the human body model m.

Thereby, it is possible to facilitate the specification of influence on the human body model m and to facilitate the specification of a location where a component is not likely to be grasped. Here, the second determination unit 305 determines the presence or absence of influence on the human body model m, but the determination performed by the second determination unit 305 is determination indicating that there is the possibility of influence being exerted on the human body model m. For this reason, the presence or absence of final influence may be determined by a designer or the like, based on determination results of the second determination unit 305.

Next, referring back to a description of FIG. 3, the third determination unit 306 finds influence on a work procedure due to the change of a connection relationship between a first component and a fourth component other than the first component among a plurality of components, based on first scene information 321-1x and second scene information 321-2y. Examples of the work procedure include an assembling procedure, a disassembling procedure, a maintenance procedure in which assembling and disassembling are combined with each other, and the like.

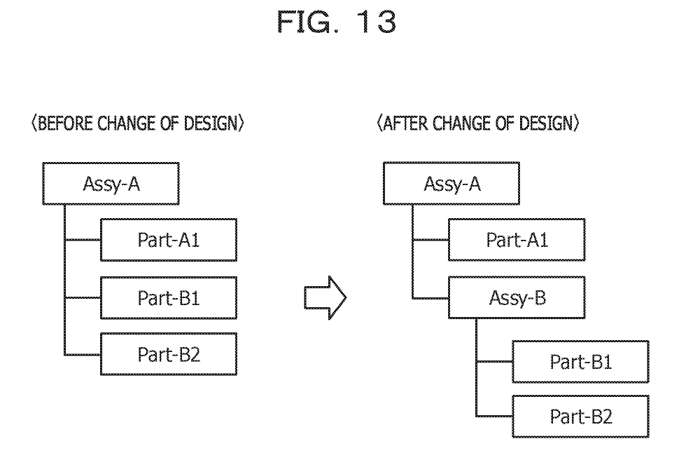

FIG. 13 is a diagram illustrating an example of the influence on an assembling order due to the change of a connection relationship between components. In FIG. 13, a first component is, for example, a component Part-B1, and a fourth component is, for example, a component Part-B2. In the example of FIG. 13, a component Assy-A includes a component Part-A1, the component Part-B1, and the component Part-B2 before the change of design. The component Assy-A includes the component Part-A1 and a component Assy-B after the change of design. A connection relationship between the component Part-B1 and the component Part-B2 is changed before and after the change of design. For this reason, the third determination unit 306 determines that influence is exerted on a work procedure due to the change of the connection relationship.

Specifically, for example, the third determination unit 306 extracts relationship information indicating a relationship between components from component information 501 included in a scene to be processed before and after the change of design in an assembled state where a component of interest is assembled to an object. The assembled state refers to the final state of the scene to be processed in a case where an animation is an animation regarding assembling work of the object. In addition, the assembled state refers to the initial state of the scene to be processed in a case where an animation is an animation regarding disassembling work of the object.

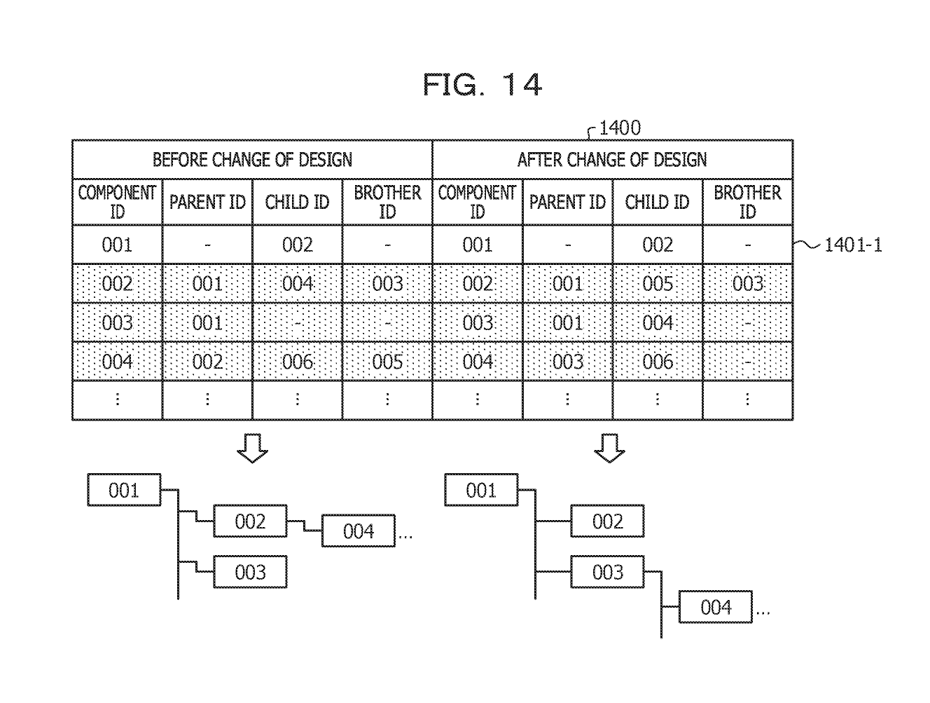

FIG. 14 is a diagram illustrating an example of relationship information. Relationship information 1400 indicates a relationship between components included in a scene to be processed. The relationship information 1400 includes fields of a self ID, a parent ID, a child ID, and a brother ID before the change of design, and fields of a self ID, a parent ID, a child ID, and a brother ID after the change of design. Information is set in the fields, and thus records (1401-1 and the like) are stored. The relationship information 1400 is stored in the storage unit 310.

Next, for example, the third determination unit 306 determines whether pieces of information in the relationship information 1400 before and after the change of design are different from each other by the comparison thereof, based on coincidence comparison data 313. More specifically, for example, the third determination unit 306 determines whether component IDs having a correlation in the coincidence comparison data 313 differ from each other in a parent ID, a child ID, and brother ID by the comparison thereof. The third determination unit 306 determines that the replacement of a component before the change of design is the same as that after the change of design.

The third determination unit 306 determines that influence is exerted on a work procedure in a case where it is determined that there is a difference, and generates information indicating the difference. The generated information indicating the difference is stored in the storage unit 310. On the other hand, the third determination unit 306 determines that influence is not exerted on a work procedure in a case where there is no difference. In the example of FIG. 14, there is a difference before and after the change of design in that a component having a component ID of “004” is included in a component having a component ID of “002” before the change of design, while a component having a component ID of “004” is included in a component having a component ID of “003” after the change of design. For this reason, the third determination unit 306 determines that there is a difference before and after the change of design.

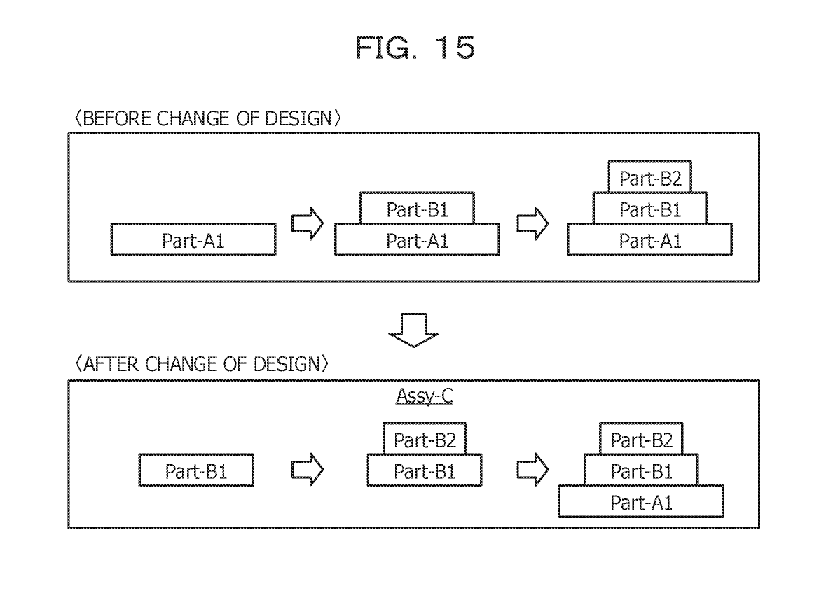

FIG. 15 is a diagram illustrating an example of the change of an animation. Here, an example of the change of an animation will be described using an example of a configuration of the component Assy-A illustrated in FIG. 13. In an animation in an assembling order conforming to a configuration of an object before the change of design, a component Part-A1 is disposed, and a component Part-B1 is assembled thereto, thereby finally assembling a component Part-B2.

A component Assy-C is created by the component Part-B1 and the component Part-B2 after the change of design. For this reason, for example, in an animation in an assembling order conforming to a configuration of an object after the change of design, a component Part-B1 is disposed, and a component Part-B2 is assembled thereto, thereby creating the component Assy-C. The created component Assy-C is assembled to a component Part-A1. In this manner, a user can correct the animation, based on presented information indicating a difference.

Next, referring back to a description of FIG. 3, the fourth determination unit 307 finds influence on the visibility of a fifth component other than a first component due to the first component, based on first scene information 321-1x and second scene information 321-2y of a scene to be processed. As described above, the first component is a component to be subjected to the change of design, and the fifth component is a component other than the first component. The influence on visibility includes, for example, a change in the degree of hiddenness of the fifth component, a change in the degree of appearance of the fifth component, and the like.

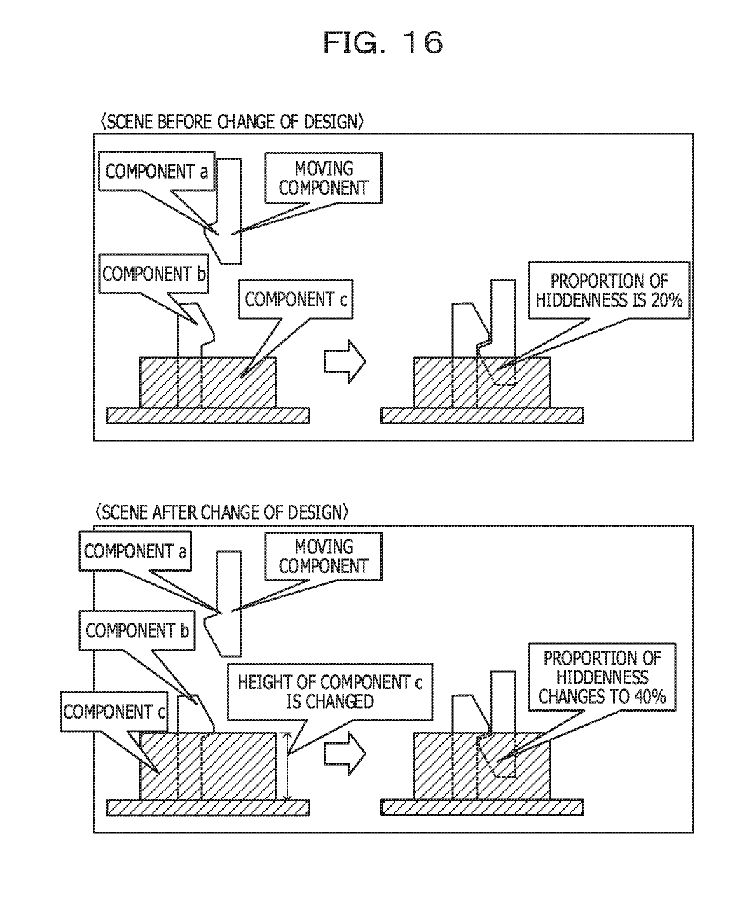

FIG. 16 is a diagram illustrating an example of the influence of visibility. In FIG. 16, a first component is, for example, a component c. In FIG. 16, a fifth component is, for example, a component a. The component a is a moving component. In an animation before the change of design, when the component a moves, approximately 20% of the component a is hidden by the component c. The height of the component c after the change of design becomes larger. For this reason, in an animation after the change of design, when the component a moves, approximately 40% of the component a is hidden by the component c.

In the example of FIG. 16, a case of hiddenness is described, but a component having disappeared due to the change of design may come into view.

The fourth determination unit 307 finds influence on visibility, for example, based on the degree of visual recognition of a fifth component due to the first component before the change in a case of being viewed from a point of view and the degree of visual recognition of the fifth component due to the first component after the change in a case of being viewed from a point of view. Examples of the degree of visual recognition include the proportion in which the surface of the fifth component is hidden by the first component in a case of being viewed from a point of view, the proportion of locations where the surface of the fifth component is not hidden by the first component in a case of being viewed from a point of view, and the like. In addition, the degree of visual recognition may be, for example, the area of the surface of the fifth component which is hidden by the first component or the number of polygons of the surface. In addition, the degree of visual recognition may be the area of the surface of the fifth component which is hidden by the first component, the number of polygons of the surface of the fifth component which is hidden by the first component, or the like.

The fourth determination unit 307 derives the degree of visual recognition of the fifth component due to the first component before the change, based on first product information 311-1 and first scene information 321-1x.

More specifically, the fourth determination unit 307 derives the proportion of a component of interest being hidden by another component in an assembled state, for example, based on first scene information 321-1x and component information 501 regarding a component included in a scene to be processed. The assembled state is a state where a component of interest is assembled to an object as described above, and is the final state of the scene to be processed. In a case where an animation is an animation regarding disassembling work of an object, an assembled state is the initial state of a scene to be processed.

The fourth determination unit 307 derives the proportion of a component of interest being hidden by another component in an assembled state of the component of interest, based on second scene information 321-2y and component information 501 of a component included in a scene to be processed.

The fourth determination unit 307 stores a proportion, which is derived each before and after the change of design, in the storage unit 310 as proportion information.

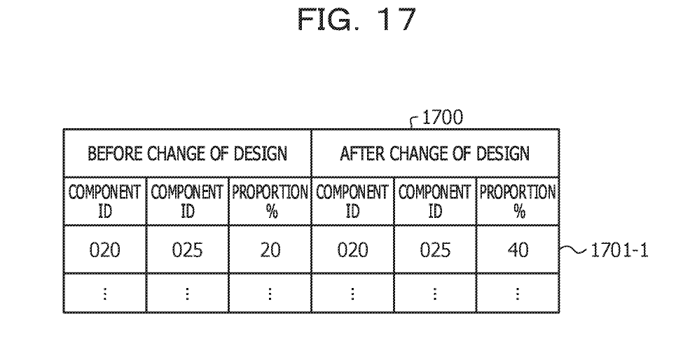

FIG. 17 is a diagram illustrating an example of proportion information. For example, proportion information 1700 includes fields of a component ID of a component of interest, a component ID of a component different from the component of interest, and a proportion before the change of design, and fields of a component ID of a component of interest, a component ID of a component different from the component of interest, and a proportion after the change of design. Information is set in the fields, and thus records (1701-1 and the like) are stored. The proportion information 1700 is stored in, for example, the storage unit 310.

A component ID of a component of interest is set in the field of a component ID of a component of interest. A component ID of a component different from the component of interest which is included in a scene to be processed is set in the field of a component ID of a component different from a component of interest. The degree of a surface of a component of interest which is hidden by a component different from the component of interest in a case of being viewed from a point of view is set in the field of a proportion.

Taking the record 1701-1 as an example, a proportion of the surface of a component of interest, having a component ID of “020” in a case of being viewed from a point of view, being hidden by a component having a component ID of “025” is 20% before the change of design. On the other hand, the surface of the component of interest, having a component ID of “020” in a case of being viewed from a point of view, being hidden by the component having a component ID of “025” is 40% after the change of design.

For example, the fourth determination unit 307 may compare the proportions before and after the change of design with each other and may generate comparison results.

More specifically, for example, the fourth determination unit 307 may determine whether a variation in proportion before and after the change of design is equal to or greater than a predetermined value to thereby determine whether influence is exerted on the visibility of a fifth component. The predetermined value is designated by, for example, a user. In a case where the variation in proportion is equal to or greater than the predetermined value, the fourth determination unit 307 determines whether influence is exerted on the visibility of the fifth component. On the other hand, in a case where the variation in proportion is not equal to or greater than the predetermined value, the fourth determination unit 307 determines that influence is not exerted on the visibility of the fifth component.

In addition, for example, in a case where the hiddenness of the component of interest from a point of view after the change of design is desired to be detected, the fourth determination unit 307 determines that influence is exerted on the visibility of the fifth component when a value obtained by subtracting the proportion before the change of design from the proportion after the change of design is equal to or greater than a predetermined value. The predetermined value is designated by, for example, a user. When the value obtained by the subtraction is not equal to or greater than the predetermined value, the fourth determination unit 307 determines that influence is not exerted on the visibility of the fifth component.

For example, in a case where the excessive viewing of the component of interest from a point of view after the change of design is desired to be detected, the fourth determination unit 307 determines that influence is exerted on the visibility of the fifth component when a value obtained by subtracting the proportion before the change of design from the proportion after the change of design is equal to or greater than a predetermined value. The predetermined value is designated by, for example, a user. When the value obtained by the subtraction is not equal to or greater than the predetermined value, the fourth determination unit 307 determines that influence is not exerted on the visibility of the fifth component.

The output unit 309 outputs a determination result, indicating the presence of influence, which is obtained by any of the first determination unit 304 to the second determination unit 305.

When the output unit 309 displays a series of situations indicated by second scene information 321-2y and a plurality of situations indicated by second animation information 312-2, the output unit displays the situations in association with results of processing for finding influence. The determination result processing unit 308 may generate, for example, output contents, and the output unit 309 may display the generated output contents.

Specifically, for example, the determination result processing unit 308 generates information for presenting a determination result, indicating the presence of influence, which is obtained by any of the first determination unit 304 to the second determination unit 305. Specifically, the determination result processing unit 308 generates a screen for displaying the determination result.

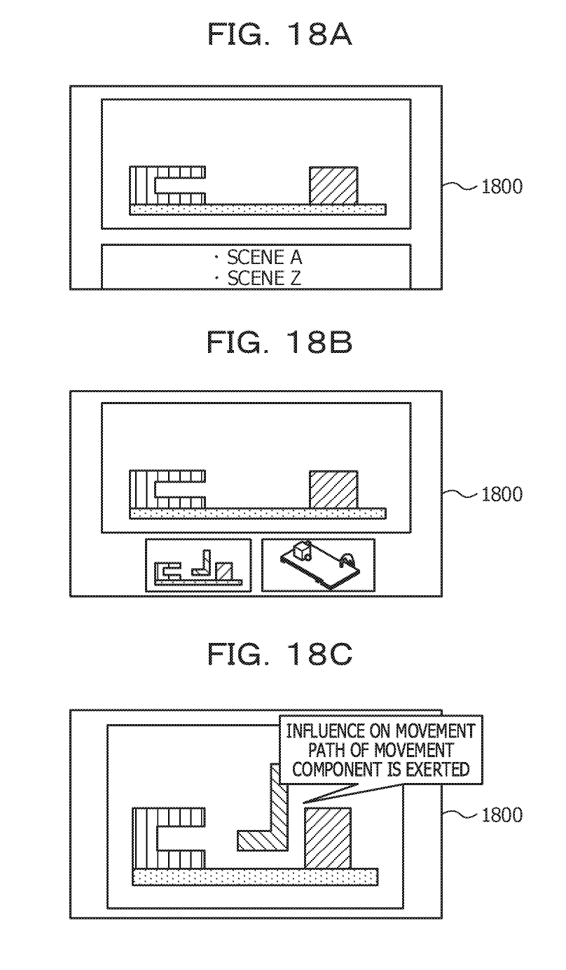

FIGS. 18A to 18C are diagrams illustrating an example of a screen. As illustrated in FIG. 18A, for example, the determination result processing unit 308 may set a scene, in which it is determined that influence is exerted, in a screen 1800 for displaying an animation after the change of design, as a link destination.

In addition, as illustrated in FIG. 18B, the determination result processing unit 308 may set a thumbnail of any of situations included in a scene, in which it is determined that influence is exerted, in a screen 1800 for displaying an animation after the change of design.

In addition, as illustrated in FIG. 18C, for example, the determination result processing unit 308 attaches information having a location being influenced and contents, in which it is determined that influence is exerted, being associated with each other, to a screen 1800 for reproducing a screen in which it is determined that influence is exerted in an animation after the change of design.

In addition, the determination result processing unit 308 sets a scene, in which it is determined that influence is not exerted, to be reproduced at high speed during the reproduction of an animation after the change of design. The determination result processing unit 308 may set a scene, in which it is determined that influence is exerted, to be reproduced at low speed.

Example of Processing Procedure Performed by Information Processing Apparatus 100

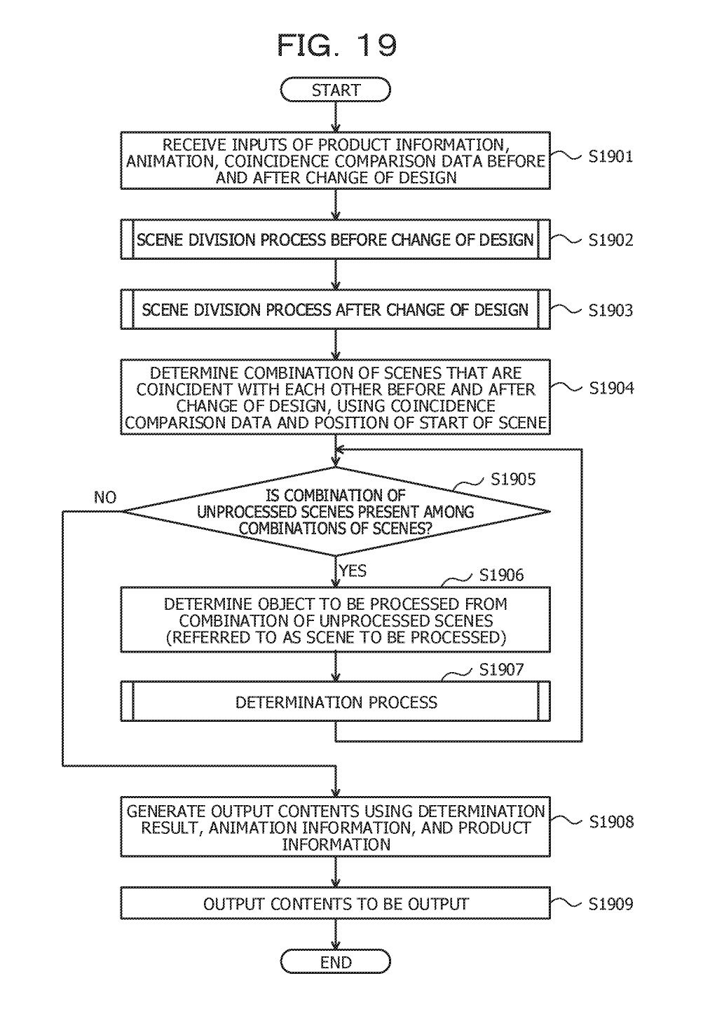

FIG. 19 is a flow chart illustrating an example of a processing procedure performed by an information processing apparatus. First, the information processing apparatus 100 receives, for example, inputs of product information 311, an animation, and coincidence comparison data 313 before and after the change of design by the input reception unit 301 (step S1901).

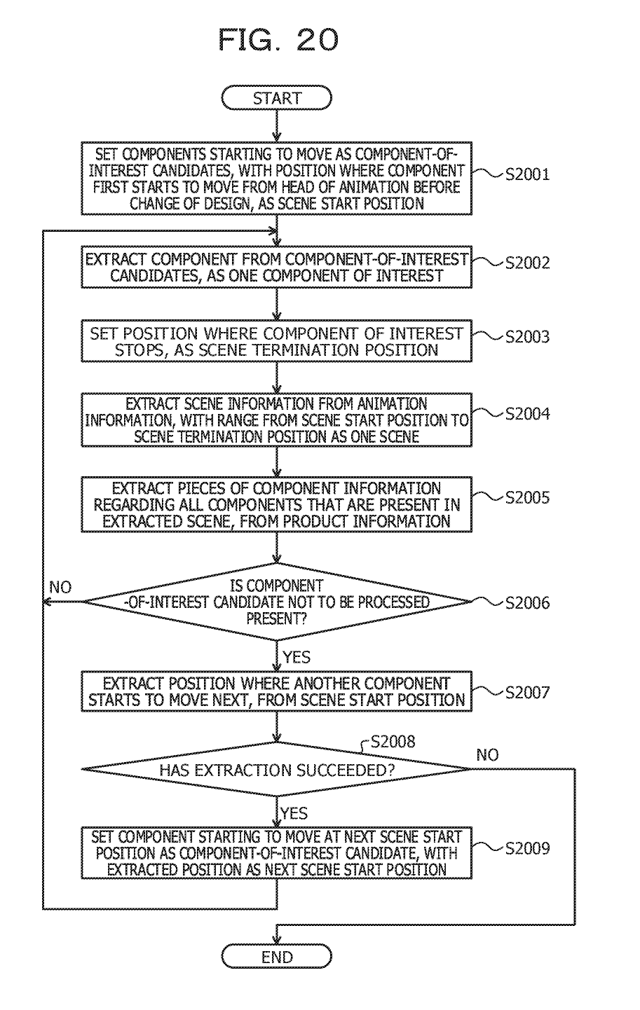

The information processing apparatus 100 performs a scene division process before the change of design by the division unit 302 (step S1902). Detailed processing of the division process in step S1902 will be described with reference to FIG. 20. The information processing apparatus 100 performs a scene division process after the change of design by the division unit 302 (step S1903). Detailed processing of the division process in step S1903 is the same processing as that of the division process in step S1902, and information to be processed is just information after the change of design, and thus a detailed description thereof will be omitted here.

The information processing apparatus 100 determines a combination of scenes that are coincident with each other before and after the change of design, using the coincidence comparison data 313 and the position of the start of a scene (step S1904). The information processing apparatus 100 determines whether a combination of unprocessed scenes is present among combinations of scenes (step S1905). In a case where it is determined that a combination of unprocessed scenes is present (step S1905: Yes), the information processing apparatus 100 determines an object to be processed from the combination of unprocessed scenes (step S1906). Here, a combination of scenes to be processed will be simply referred to as a scene to be processed.

The information processing apparatus 100 performs a determination process by the first determination unit 304 to the fourth determination unit 307 (step S1907), and returns to step S1905. In a case where it is determined in step S1905 that a combination of unprocessed scenes is not present (step S1905: No), the information processing apparatus 100 creates output contents using results of determination performed by the determination result processing unit 308, animation information 312 regarding an animation, and product information 311 (step S1908). The information processing apparatus 100 outputs output contents by the output unit 309 (step S1909), and terminates a series of processes. In step S1909, the information processing apparatus 100 may display, for example, output contents on the display 209 or the like.

FIG. 20 is a flow chart illustrating details of the division process (step S1902) illustrated in FIG. 19. First, the information processing apparatus 100 sets components starting to move as component-of-interest candidates, with the position where a component first starts to move from the head of an animation indicated by animation information 312 before the change of design, as a scene start position (step S2001).

The information processing apparatus 100 extracts a component from the component-of-interest candidates, as one component of interest (step S2002). The information processing apparatus 100 sets a position where the component of interest stops, as a scene termination position (step S2003).

The information processing apparatus 100 extracts scene information 321 from the animation information 312, with a range from the scene start position to the scene termination position as one scene (step S2004). The information processing apparatus 100 extracts pieces of component information 501 regarding all components that are present in a scene indicated by the extracted scene information 321, from product information 311 (step S2005).

The information processing apparatus 100 determines whether a component-of-interest candidate not to be processed is present (step S2006). In a case where it is determined that a component-of-interest candidate is present (step S2006: Yes), the information processing apparatus 100 extracts a position where another component starts to move next, from the scene start position (step S2007). The information processing apparatus 100 determines whether the extraction has succeeded (step S2008).

In a case where it is determined that the extraction has succeeded (step S2008: Yes), the information processing apparatus 100 sets a component starting to move at the next scene start position as a component-of-interest candidate, with the extracted position as the next scene start position (step S2009). The information processing apparatus returns to step S2002. In a case where it is determined in step S2006 that a component-of-interest candidate is not present (step S2006: No), the information processing apparatus 100 returns to step S2002.

In a case where it is determined in step S2008 that the extraction has not succeeded (step S2008: No), the information processing apparatus 100 terminates a series of processes.

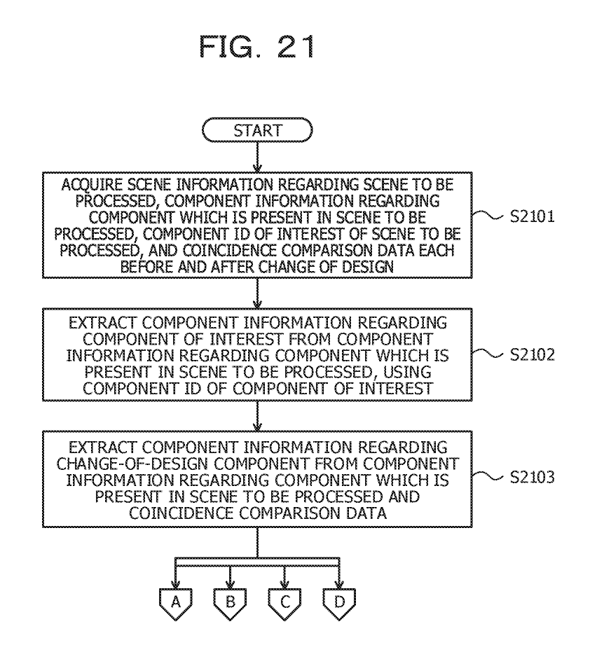

FIGS. 21 to 25 are flow charts illustrating details of the determination process (step S1907) illustrated in FIG. 19. First, FIG. 21 illustrates preprocessing of each of processes of the first determination unit 304 to the fourth determination unit 307. The information processing apparatus 100 acquires scene information 321 regarding a scene to be processed, component information 501 regarding a component which is present in the scene to be processed, a component ID of interest of a scene to be processed, and coincidence comparison data 313 each before and after the change of design (step S2101). The scene information 321 regarding a scene to be processed is scene information 321 indicating a scene to be processed.

The information processing apparatus 100 extracts component information 501 regarding a component of interest from the component information 501 regarding a component which is present in a scene to be processed, using a component ID of a component of interest (step S2102). The information processing apparatus 100 extracts component information 501 regarding a change-of-design component, from the component information 501 regarding a component which is present in a scene to be processed and coincidence comparison data 313 (step S2103), and proceeds to step S2201, step S2301, step S2401, and step S2501.

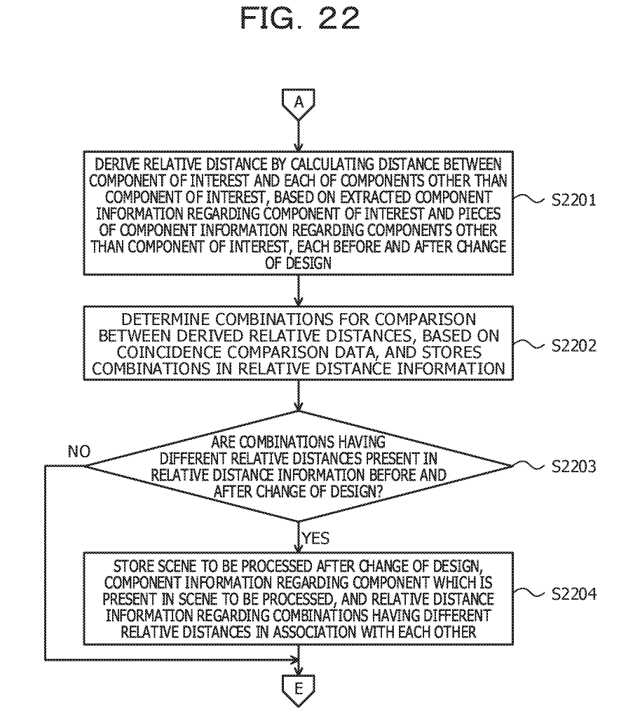

Next, in FIG. 22, a procedure of finding influence on a movement path of a movement component due to the change of design by the first determination unit 304 will be described. The information processing apparatus 100 derives a relative distance by calculating a distance between a component of interest and each of components other than the component of interest, based on extracted component information 501 regarding the component of interest and pieces of component information 501 regarding the components other than the component of interest, each before and after the change of design (step S2201).

The information processing apparatus 100 determines combinations for comparison between the derived relative distances, based on the coincidence comparison data 313, and stores the combinations in relative distance information 1000 (step S2202). The information processing apparatus 100 determines whether combinations having different relative distances before and after the change of design are present in the relative distance information 1000 (step S2203). In a case where it is determined that combinations having different relative distances are present (step S2203: Yes), the information processing apparatus 100 stores a scene to be processed after the change of design, component information 501 regarding a component which is present in the scene to be processed, and relative distance information 1000 regarding the combinations having different relative distances in the storage unit 310 in association with each other (step S2204), and proceeds to step S2505.

In a case where it is determined in step S2203 that combinations having different relative distances are not present before and after the change of design (step S2203: No), the information processing apparatus 100 proceeds to step S2505.

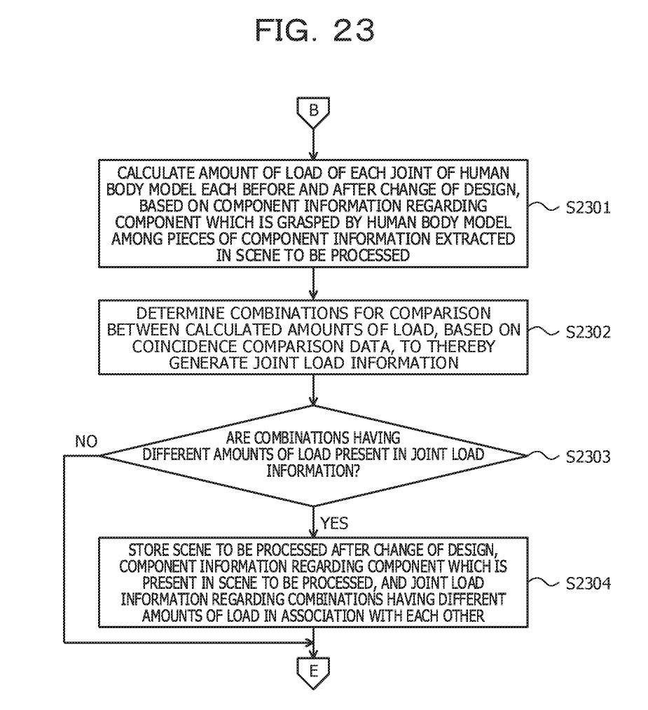

In FIG. 23, a processing procedure of finding influence on a human body due to the change of design by the second determination unit 305 will be described. The information processing apparatus 100 calculates the amount of load of each joint of a human body model m each before and after the change of design, based on component information 501 regarding a component which is grasped by the human body model m among pieces of component information 501 extracted in a scene to be processed (step S2301). The information processing apparatus 100 determines combinations for comparison between the calculated amounts of load, based on the coincidence comparison data 313, to thereby generate joint load information 1200 (step S2302).

The information processing apparatus 100 compares the amounts of load of combinations for comparison with each other and determines whether combinations having different amounts of load are present in the joint load information 1200 (step S2303). In a case where it is determined that combinations having different amounts of load are present (step S2303: Yes), the information processing apparatus 100 stores a scene to be processed after the change of design, component information 501 regarding a component which is present in the scene to be processed, and joint load information 1200 regarding combinations having different amounts of load in the storage unit 310 in association with each other (step S2304), and proceeds to step S2505.

In a case where it is determined that combinations having different amounts of load are not present (step S2303: No), the information processing apparatus 100 proceeds to step S2505.

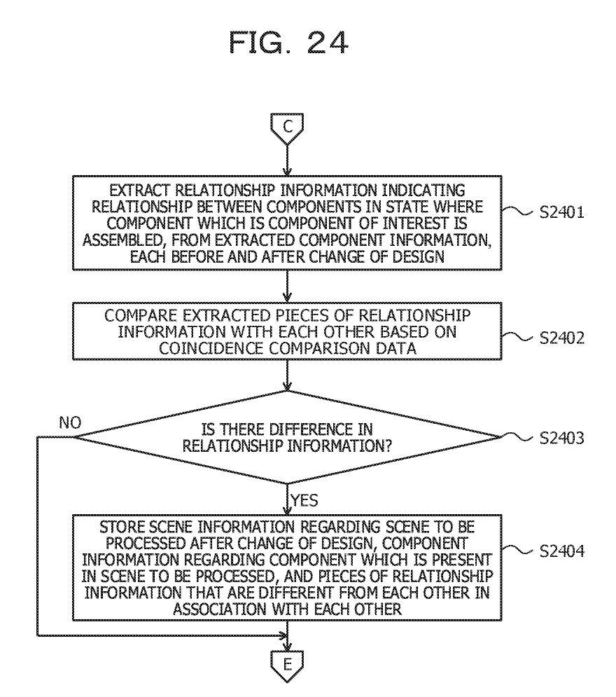

In FIG. 24, a processing procedure of finding influence on a work procedure due to the change of a connection relationship between components by the third determination unit 306 will be described. The information processing apparatus 100 extracts relationship information 1400 indicating a relationship between components in a state where a component which is a component of interest is assembled, from extracted component information 501, each before and after the change of design (step S2401).

The information processing apparatus 100 compares the extracted pieces of relationship information 1400 with each other based on coincidence comparison data 313 (step S2402). The information processing apparatus 100 determines whether there is a difference between the pieces of relationship information 1400 (step S2403). In a case where it is determined that there is no difference between the pieces of relationship information 1400 (step S2403: No), the information processing apparatus 100 proceeds to step S2505.

In a case where it is determined that there is a difference between the pieces of relationship information 1400 (step S2403: Yes), the information processing apparatus 100 stores scene information 321 regarding a scene to be processed after the change of design, component information 501 regarding a component which is present in the scene to be processed, and the pieces of relationship information 1400 that are different from each other in in the storage unit 310 in association with each other (step S2404), and proceeds to step S2505.

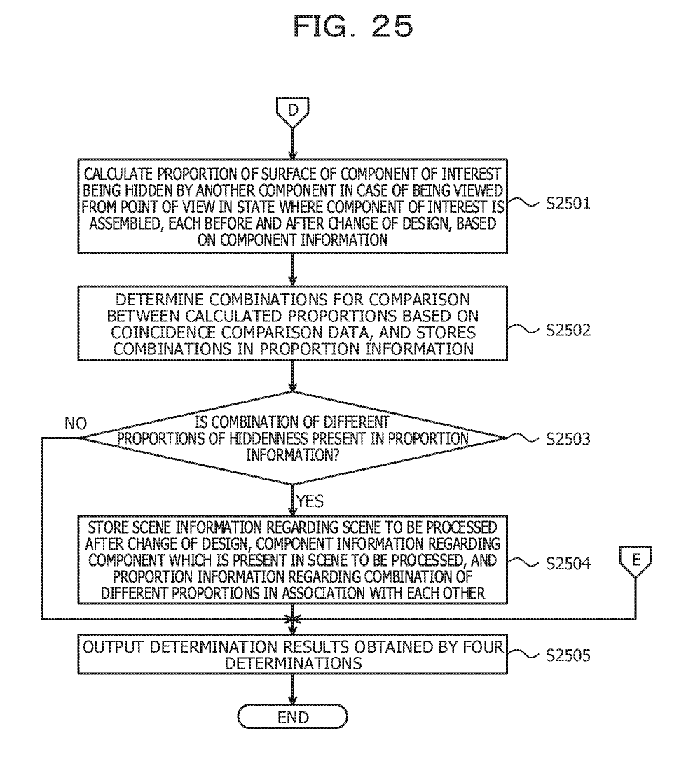

In FIG. 25, a processing procedure of finding influence on the visibility of another component due to the change of design by the fourth determination unit 307 will be described. The information processing apparatus 100 calculates the proportion of the surface of a component of interest being hidden by another component in a case of being viewed from a point of view in a state where the component of interest is assembled, each before and after the change of design, based on component information 501 (step S2501). The information processing apparatus 100 determines combinations for comparison between the calculated proportions based on coincidence comparison data 313, and stores the combinations in proportion information 1700 (step S2502).

The information processing apparatus 100 determines whether a combination of different proportions of hiddenness is present in the proportion information 1700 (step S2503). In a case where it is determined that a combination of different proportions is not present (step S2503: No), the information processing apparatus 100 proceeds to step S2505.

In a case where a combination of different proportions is present (step S2503: Yes), the information processing apparatus 100 stores scene information 321 regarding a scene to be processed after the change of design, component information 501 regarding a component which is present in the scene to be processed, and the proportion information 1700 regarding a combination of different proportions in association with each other (step S2504). The information processing apparatus 100 outputs determination results obtained by the four determinations (step S2505), and terminates a series of processes.

As described above, the information processing apparatus 100 finds influence on work with respect to an object including a component after the change, due to the change of the component, based on scene information regarding the object including the component before the change and scene information regarding the object including the component after the change. Thereby, it is possible to ascertain influence on a scene.

In addition, the information processing apparatus 100 finds influence on a movement path of a movement component to thereby find influence on work with respect to an object. In a case where the positions of the movement component and another component become closer to each other or become more distant from each other during the movement of the movement component than those before design, there is a possibility that influence, for example, work such as disassembling or assembling of the movement component not being likely to be performed is exerted. For this reason, it is possible to facilitate the creation of an animation regarding an efficient work by finding influence on a movement path of a movement component.

In addition, the information processing apparatus 100 finds influence on a movement component, based on a distance between the movement component and another component each before and after the change of design. It is possible to easily specify a positional relationship between the movement component and another component and to facilitate an examination such as the correction of a movement path of the movement component. In addition, for example, influence is exerted on the movement path of the movement component, and thus an examination such as the change of a work procedure may be performed.

In addition, the information processing apparatus 100 finds influence on a movement component, based on a distance between the movement component and a component after the change and a distance between the movement component of the component before the change.

In addition, the information processing apparatus 100 finds influence on a human body due to a first component after the change in a case where a third component including the first component among a plurality of components is held by the human body in a simulation space. Thereby, it is possible to facilitate an examination of work such as a difficulty in grasping the third component by a human body due to the change of design. For example, the human body is not likely to grasp the third component, and thus an examination such as the change of a work procedure may be performed.

In addition, the information processing apparatus 100 finds influence on a human body, based on the amount of load on a joint of the human body before and after the change of design. For example, when the amount of load on a joint increases, the human body's grasping is not likely to be performed. In this manner, it is possible to easily specify influence on the human body.

In addition, the information processing apparatus 100 finds influence on a procedure of work due to the change of a connection relationship between a certain component and another component. Thereby, it is possible to facilitate the change of an assembling order or a disassembling order.

In addition, the information processing apparatus 100 finds influence on the visibility of a component other than a component to be changed among a plurality of components, due to the component after the change. For example, a component is not likely to be viewed during work, and thus it is possible to specify influence on work such as not being likely to perform work. In addition, for example, a component is not likely to be viewed during work, and thus it is possible to facilitate an examination such as the change of a work procedure.

In addition, the information processing apparatus 100 finds influence on visibility, based on the degree of visual recognition of another component due to a component after the change in a case of being viewed from a point of view and the degree of visual recognition of another component due to the component before the change in a case of being viewed from a point of view.

In addition, the information processing apparatus 100 performs at least one process among the processes of finding four influences. Thereby, it is possible to confirm influence according to contents of an animation.

In addition, the information processing apparatus 100 may perform a process selected by a designer among the four processes of finding influence. Thereby, the designer can confirm the four influences as desired, and thus it is possible to improve convenience.

Meanwhile, the design method described in the present embodiment can be realized by a computer, such as a personal computer or a workstation, executing a design program provided in advance. The design program is recorded on a computer-readable recording medium such as a magnetic disk, an optical disk, or a Universal Serial Bus (USB) flash memory, and is executed by being read out from the recording medium by a computer. In addition, the design program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable storage medium storing a design program that causes a computer to execute a process comprising:
obtaining first information and second information, the first information indicating a result of a simulation for a work including assembling or disassembling before a change of design of the object that includes a plurality of components, the second information indicating a result of the simulation for the work after the change of design; and
specifying a scene, in the work, that has potential to be influenced by the change of design based on the obtained first information and the second information.

2. The computer-readable storage medium according to claim 1,
wherein the specifying includes detecting influence on a movement path of at least one component among the plurality of components due to the change of design.

3. The computer-readable storage medium according to claim 2, wherein the process further comprises:
obtaining first object information indicating the component and a position of the component with respect to each of the plurality of components before the change of design, and second object information indicating the component and a position of the component with respect to each of the plurality of components after the change of design;
wherein the detecting influence on the movement path includes detecting the influence on the movement path based on a distance between the first component to be moved and components other than the first component before the change, determined based on the first object information, and based on a distance between the first component and the components other than the first component after the change determined based on the second object information.

4. The computer-readable storage medium according to claim 1,
wherein the specifying includes detecting influence on a human body due to the change of design in a case where the human body holds the object based on the received first information and second information.

5. The computer-readable storage medium according to claim 4, wherein the process further comprises:
obtaining first object information indicating the component and a position of the component with respect to each of the plurality of components before the change of design, and second object information indicating the component and a position of the component with respect to each of the plurality of components after the change of design;
wherein the detecting influence on the human body includes detecting influence on the human body based on an amount of load of each joint of the human body in a case where the human body holds the object before the change, determined based on the first object information, and based on an amount of load of each joint of the human body in a case where the human body holds the object after the change of design determined based on the second object information.

6. The computer-readable storage medium according to claim 1,
wherein the specifying includes detecting influence on a procedure of the work due to a change of a connection relationship between the plurality of components based on the received first information and second information.

7. The computer-readable storage medium according to claim 6,
wherein the detecting influence on the procedure of the work includes detecting influence on the procedure of the work with respect to the object after the change of design, based on a connection relationship between components included in the plurality of components before the change of design, and a connection relationship between components included in the plurality of components after the change of design.

8. The computer-readable storage medium according to claim 1,
wherein the specifying includes detecting influence on visibility of a specified component included in the plurality of components due to the change of design based on the received first information and second information.

9. The computer-readable storage medium according to claim 8, the process further comprising:
obtaining first object information indicating the component and a position of the component with respect to each of the plurality of components before the change of design, and second object information indicating the component and a position of the component with respect to each of the plurality of components after the change of design;
wherein the first information and the second information include point-of-view information indicating a point of view from which a scene included in the simulation is viewed,
wherein the detecting influence on visibility includes detecting influence on the visibility based on a degree of visual recognition of the specified component before the change of design in a case of being viewed from the point of view indicated by the point-of-view information, determined based on the received first object information, and based on a degree of visual recognition of the specified component after the change of design in a case of being viewed from the point of view indicated by the point-of-view information determined based on the received second object information.

10. A design apparatus comprising:
a memory; and
a processor configured to:
obtain first information and second information, the first information indicating a result of a simulation for a work including assembling or disassembling before a change of design of the object that includes a plurality of components, the second information indicating a result of the simulation for the work after the change of design; and
specify a scene, in the work, that has potential to be influenced by the change of design based on the obtained first information and the second information.

11. A design method comprising:
obtaining first information and second information, the first information indicating a result of a simulation for a work including assembling or disassembling before a change of design of the object that includes a plurality of components, the second information indicating a result of the simulation for the work after the change of design; and
specifying a scene, in the work, that has potential to be influenced by the change of design based on the obtained first information and the second information.
